(19) United States
(12) Patent Application Publication
(10) Pub. No.: US 2026/0067844 A1
(43) Pub. Date: Mar. 5, 2026

(54) IDENTIFICATION OF DEVICES TO PARTICIPATE IN SITE-WIDE CALL

(71) Applicant: MOTOROLA SOLUTIONS, INC., Chicago, IL (US)

(72) Inventors: Tomasz Klys, Krakow (PL); Peter Josephsen, Glostrup (DK)

(21) Appl. No.: 18/819,199

(22) Filed: Aug. 29, 2024

(51) Int. Cl. H04W 60/06; H04W 60/04; H04W 88/16

(52) U.S. Cl. CPC H04W 60/06; H04W 60/04; H04W 88/16

(57) ABSTRACT

Examples provide a communication system including an electronic processor communicatively connected to a plurality of radio frequency (RF) sites in an RF network. The electronic processor determines RF site affiliations for each of a plurality of subscribers in the RF network, and determines that a first subscriber has disconnected from the RF network and established an internet protocol (IP) connection to a gateway associated with the RF network. In response to determining that a radio device has initiated a site-wide call for a first RF site, the electronic processor determines, based on the RF site affiliations, whether the first subscriber was affiliated with the first RF site prior to disconnection from the RF network. In response to determining that the first subscriber was affiliated with the first RF site, the electronic processor transmits audio associated with the site-wide call to the first subscriber via the IP connection.

### BACKGROUND

Wireless communication devices transfer information using various communication modalities. To satisfy the needs of a particular communication system or user, some wireless communication devices include features that support communications via multiple communication modalities. Devices with such features are sometimes referred to as converged devices. Communication modalities that some converged devices are compatible with include, for example, internet protocol (IP) based communication modalities (e.g., WiFi and long term evolution (LTE) or other cellular communication protocols) and land mobile radio (LMR) protocols, such as terrestrial trunked radio (TETRA). Some converged devices are configurable to operate in accordance with multiple distinct wireless networks, for example, both LTE and LMR networks, including networks that are either public or private.

### BRIEF DESCRIPTION OF THE DRAWINGS

FIG. 1 illustrates a radio communication system, according to some examples.

FIG. 2 schematically illustrates a radio device, according to some examples.

FIG. 3 schematically illustrates an LMR over IP server, according to some examples.

FIG. 4 illustrates a radio communication system having a radio device with an IP connection, according to some examples.

FIG. 5 illustrates a method for providing site-wide call functionality for converged radio devices, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Converged wireless communication devices, often referred to herein as converged devices, are devices capable of communicating within multiple communication systems implementing different communication protocols. In some instances, converged devices include, in essence, two radios—a land mobile radio (LMR) and a broadband radio—for communicating in an internet protocol (IP) based communication system (e.g., a WiFi communication system, a long term evolution (LTE) communication system, or another IP based communication system). Communication protocols that may be implemented by a converged device include, for example, the Project 25 (P25) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, among other possibilities.

Converged devices may be configured to switch transmission from a first communication protocol, or modality, to a second communication protocol or modality based on coverage information related to the respective communication modalities. For example, a converged device may switch from performing communication in an LMR network to performing communication in an IP-based network when LMR coverage is below a quality or availability threshold (e.g., when the converged device is at an edge of an LMR network cell, underground, or otherwise experiencing signal interference).

When operating according to the IP-based communication protocol, the converged device may communicate with an IP-enabled gateway server, otherwise referred to as an LMR over IP server, associated with the LMR network. The LMR over IP server operates as a gateway to the LMR network and therefore enables the converged device to continue communications in the LMR network even when LMR coverage is insufficient. However, when a conventional converged device operates over an IP network, some operational features of the LMR network become unavailable. One such feature is site-wide call functionality. Site-wide calling enables a subscriber to the LMR network or a dispatcher wired to the LMR network to transmit a broadcast call to all radio devices affiliated with a particular radio frequency (RF) site (e.g., a particular LMR base station) or a particular geographic region.

A dispatcher or other subscriber may initiate a site-wide call for an LMR site to notify all personnel of an event near LMR site. For example, a dispatcher may initiate a site wide call for a geographical region (e.g., one or more LMR sites) to warn first responders of a large scale emergency (e.g., a tornado touch down, flash flood, vehicle pileup, airplane crash, train derailment, or the like).

As another example, all personnel in a mining operation must be informed of explosives being set off at a given site. A site-wide LMR call can enable effective communication of information related to scheduled explosions. However, some personnel in the operation may be located underground with converged radio devices that are operating using an IP connection rather than an LMR connection. Such devices are therefore unable to receive site-wide calls.

When a converged radio device is served using Wi-Fi or cellular networks, the gateway may not have access to the location information associated with the converged radio device, and therefore is unable to determine whether the converged radio device should be included in a site-wide call for a given RF site (e.g., a given geographic region associated with the RF site). While GPS tracking of radio devices may assist in determining whether a converged radio device should be included in a site-wide call for a particular geographic region, processing the GPS locations for many devices can be a time-consuming and computationally intensive process. Radio devices may also turn off GPS functionality (e.g., to save power) or lose GPS signal (e.g., when indoors or underground), which limits the effectiveness of using GPS to determine site-wide call inclusion. Additionally, privacy laws and regulations in some jurisdictions (e.g., the General Data Protection Regulation (GDPR) of the European Union) or network customer policies may prohibit or limit the use of GPS tracking of radio devices by the gateway or core network.

Thus, there is a need, among other things, for a system and method for enabling site-wide calling for converged devices that are served by an IP network, without relying on location information. One example provides a communication system including an electronic processor communicatively connected to a plurality of radio frequency (RF) sites in an RF network, the electronic processor configured to determine RF site affiliations for each of a plurality of subscribers in the RF network, determine that a first subscriber has disconnected from the RF network and established an internet protocol (IP) connection to a gateway associated with the RF network, determine that a radio device has initiated a site-wide call for a first RF site in the RF network, in response to determining that the radio device has initiated the site-wide call, determine, based on the RF site affiliations, whether the first subscriber was affiliated with the first RF site prior to disconnection from the RF network, in response to determining that, prior to disconnection from the RF network, the first subscriber was affiliated with the first RF site, transmit audio associated with the site-wide call to the first subscriber via the IP connection between the gateway and the first subscriber.

In some aspects, the electronic processor is further configured to determine that a second subscriber included in the plurality of radio devices has disconnected from the RF network and established an internet protocol (IP) connection to the gateway associated with the RF network, in response to determining that the radio device has initiated the site-wide call for the first RF site, determine, based on the RF site affiliations, whether the second subscriber was affiliated with the first RF site prior to disconnection from the RF network, in response to determining that, prior to disconnection from the RF network, the second subscriber was not affiliated with the first RF site, refrain from transmitting the audio associated with the site-wide call to the second subscriber.

In some aspects, the electronic processor is configured to, in response to determining that the radio device has initiated the site-wide call for the first RF site, determine, for each respective subscriber of the plurality of subscribers having an IP connection to the gateway, whether the respective subscriber was affiliated with the first RF site prior to establishment of the IP connection, and transmit, via the IP connection from the gateway, the audio associated with the site-wide call to each respective subscriber that has the IP connection and was affiliated with the first RF site prior to establishment of the IP connection.

In some aspects, the IP connection includes at least one selected from the group consisting of a cellular network connection and a WiFi connection.

In some aspects, the electronic processor is configured to receive the audio associated with the site-wide call from the first subscriber via a core of the RF network.

In some aspects, the electronic processor is configured to store the RF site affiliations in a memory and update the RF site affiliations stored in the memory in response to a change in an RF site affiliation for a respective one of the plurality of subscribers.

In some aspects, the electronic processor is configured to determine the RF site affiliations for each of the plurality of subscribers in the RF network based on subscriber connection information received from a core of the RF network.

In some aspects, the electronic processor is configured to determine the RF site affiliation for the first subscriber by receiving subscriber connection information from the first subscriber in response to establishment, by the first subscriber, of the IP connection to the gateway.

In some aspects, the electronic processor is configured to request the RF site affiliations from a core of the RF network.

In some aspects, the electronic processor is communicatively connected to the plurality of RF sites via a core of the RF network.

In some aspects, the RF network is an LMR network.

In some aspects, the radio device has a wired or wireless connection to the RF network.

In some aspects, the first RF site includes a first plurality of RF sites.

Another example provides a method for a communication system. The method includes determining RF site affiliations for each of a plurality of subscribers in a radio-frequency (RF) network; determining that a first subscriber included in the plurality of subscribers has disconnected from the RF network and established an internet protocol (IP) connection to a gateway associated with the RF network; determining that a radio device has initiated a site-wide call for a first RF site in the RF network; in response to determining that the radio device has initiated the site-wide call, determining, based on the RF site affiliations, whether the first subscriber was affiliated with the first RF site prior to disconnection from the RF network; in response to determining that the first subscriber was affiliated with the first RF site prior to disconnection from the RF network, transmitting audio associated with the site-wide call to the first subscriber via the IP connection between the gateway and the first subscriber.

In some aspects, the method further includes: determining that a second subscriber included in the plurality of subscribers has disconnected from the RF network and established an internet protocol (IP) connection to the gateway associated with the RF network; in response to determining that the radio device has initiated the site-wide call for the first RF site, determining, based on the RF site affiliations, whether the second subscriber was affiliated with the first RF site prior to disconnection from the RF network; and in response to determining that, prior to disconnection from the RF network, the second subscriber was not affiliated with the first RF site, refraining from transmitting the audio associated with the site-wide call to the second subscriber.

In some aspects, the method further includes: in response to determining that the radio device has initiated the site-wide call for the first RF site, determining, for each respective subscriber of the plurality of subscribers having an IP connection to the gateway, whether the respective subscriber was affiliated with the first RF site prior to establishment of the IP connection; and transmitting, using the IP connection from the gateway, the audio associated with the site-wide call to each respective subscriber that has the IP connection and was affiliated with the first RF site prior to establishment of the IP connection.

In some aspects, the IP connection includes at least one selected from the group consisting of a cellular network connection and a WiFi connection.

In some aspects, the method further includes: receiving the audio associated with the site-wide call from the first subscriber via a core of the RF network.

In some aspects, the method further includes: storing the RF site affiliations in a memory and updating the RF site affiliations stored in the memory in response to a change in an RF site affiliation for a respective one of the plurality of subscribers.

In some aspects, the method further includes determining the RF site affiliations for each of the plurality of subscribers in the RF network based on subscriber connection information received from a core of the RF network.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct or cause a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the FIG.

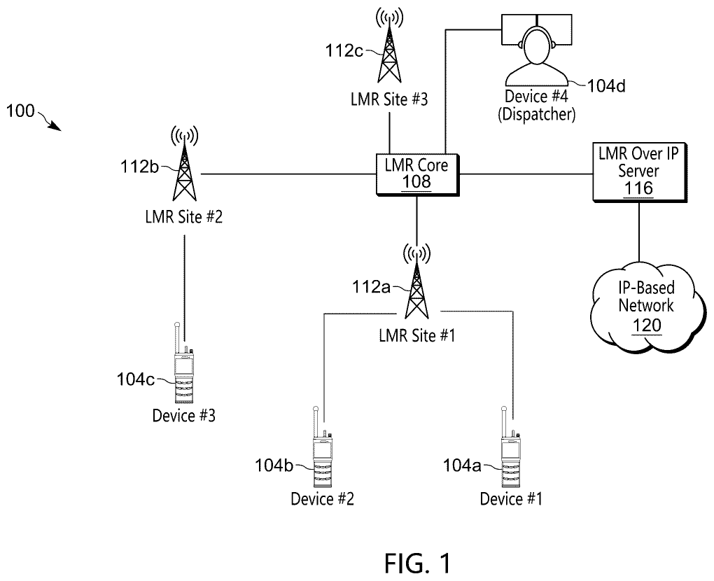

Referring now to the drawings, FIG. 1 illustrates a communication system 100, according to some examples. The communication system 100 includes a plurality of radio devices 104 operable in an RF network that is comprised of a core network 108 and a plurality of RF sites 112. By way of example, the RF network may be described herein as an LMR network (such as a TETRA network or the like), the core network 108 may be described as an LMR core 108, and the RF sites 112 may be described as LMR sites 112 or LMR base stations 112. While illustrated in FIG. 1 as having three LMR sites 112 (e.g., three LMR sites 112a-112c), the communication system 100 may include more than three LMR sites 112 or less than three LMR sites. Similarly, the number of radio devices 104 operating in the communication system 100 may vary, and may include more than four radio devices 104 or less than four radio devices 104.

The radio devices 104 may include portable radio devices, mobile radio devices, dispatcher consoles, or the like. The radio devices 104 may have a wired or wireless connection to the LMR network (e.g., the LMR core 108). In the illustrated example, the plurality of radio devices 104 includes first, second, and third radio devices 104a-104c connected (e.g., as subscribers) to the LMR network via the LMR base stations 112. Each such radio device 104 may be affiliated with, or served by, the LMR site that 112 that is nearest to the respective radio device 104. For example, the first and second radio devices 104a-104b is affiliated with the first LMR site 112a, and the third radio device is affiliated with the second LMR site 112b. A fourth radio device 104d is, for example, a dispatcher radio device 104d having a wired connection to the LMR core 108. However, in some instances, the dispatcher radio device 104d has a wireless connection to the LMR core 108.

The communication system 100 also includes an LMR over IP server 116 that operates as a gateway between the LMR core 108 and an IP-based network 120 (e.g., at least one IP-based network 120). The IP-based network 120 may include, for example, a cellular network, a Wi-Fi network, or other broadband communication system.

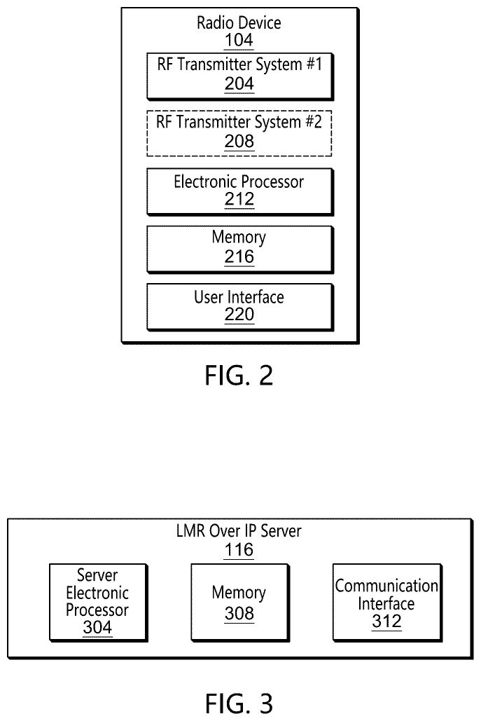

FIG. 2 schematically illustrates a radio device 104, according to some examples. In the example illustrated in FIG. 2, the radio device 104 includes a first radio-frequency (RF) transmitter system 204 configured to transmit communication signals according to a first communication protocol and a second RF transmitter system 208 configured to transmit communication signals according to a second communication protocol different from the first communication protocol. The radio device 104 also includes a radio device electronic processor 212 (i.e., one or more radio device electronic processors 212) configured to control operation of the radio device 104. A memory 216 stores information related to operation of the radio device 104, such as software or program instructions that, when executed by the radio device electronic processor 212, cause the electronic processor to perform, among other things, the methods described herein. The memory 216 may further store certificates, shared keys, or other data used for performing communication according to the first or second communication protocols.

The radio device 104 further includes a user interface 220. The user interface 220 includes, among other things, a microphone for receiving voice data from a user of the radio device 104 to be transmitted using the first RF transmitter system 204 and/or the second RF transmitter system 208. The user interface 220 may also include a speaker for outputting, to the user, sound data received via the first RF transmitter system 204 and/or the second RF transmitter system 208.

FIG. 3 schematically illustrates the LMR over IP server 116, according to some examples. In the example illustrated in FIG. 3, the LMR over IP server 116 includes a server electronic processor 304 (e.g., one or more server electronic processors 304) communicatively connected to a memory 308 (e.g., one or more memories 308) and a communication interface 312 (e.g., one or more communication interfaces 312). The memory 308 stores information associated with operation of the LMR over IP server 116 as a gateway between the RF network (formed by the RF core 108 and the RF sites 112) and the IP-based network 120. In some instances, the LMR over IP server 116 is implemented in a distributed manner. For example, a portion of the functionality of the LMR over IP server 116 (e.g., functionality of the server electronic processor 304) may be implemented using the LMR core 108.

Referring again to FIG. 1, during operation of the radio devices 104 in the system 100, a radio device (e.g., any one of the radio devices 104a-104d) may initiate a site-wide call for a particular LMR site 112. For example, the first radio device 104a may initiate a site-wide call for the respective LMR site to which the first radio device 104a is connected (e.g., the first LMR site 112a. During the site-wide call, audio is transmitted from the first radio device 104a (e.g., using the first RF transmitter system 204) to all other radio devices 104 actively connected to the first LMR site 112a (e.g., to the second radio device 104b according to the example illustrated in FIG. 1). In this manner, all devices in a particular geographic region may receive the same communications.

In some instances, the site-wide call is initiated for multiple RF sites. For example, the dispatcher radio device 104d may initiate a site-wide call for both the first LMR site 112a and the second LMR site 112b. Therefore, each of the radio devices 104a-104c that are connected to either the first LMR site 112a or the second LMR site 112c may receive the same audio transmissions from the dispatcher radio device 104d.

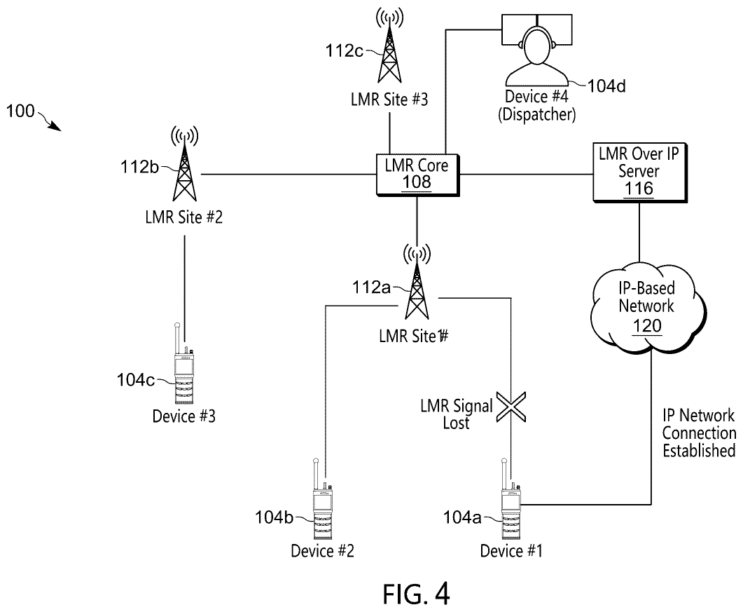

Referring now to FIG. 4, a subscriber radio device (e.g., the first radio device 104a) may lose an LMR connection to a respective LMR site (e.g., the first LMR site 112a) without connecting to a different LMR site. For example, the first radio device 104a may have moved underground, inside a building, outside range of any LMR sites 112, or the like. In such instances, the first radio device 104a, may transmit and receive audio signals to and from the LMR over IP server 116 using the IP-based network 120. Operating as a gateway, the LMR over IP server 116 in turn transmits audio signals received from the first radio device 104a to the LMR core 108, and transmits audio signals received from the LMR core 108 to the first radio device 104a as needed.

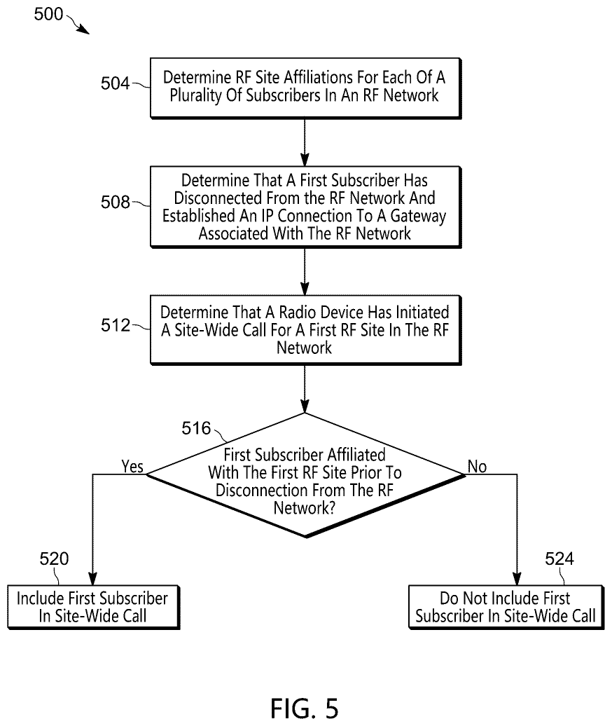

As described above, in some conventional RF communication systems, site-wide call functionality is not available for radio devices that are not actively connected to an RF site (e.g., the first radio device 104a in the example of FIG. 4). FIG. 5 illustrates an example method 500 for identifying radio devices to participate in site-wide calls but are served by an IP network (e.g., the IP-based network 120). The method 500 is performed by, for example, the server electronic processor 304 in conjunction with other components of the system 100 (e.g., the radio devices 104, the LMR core 108, the LMR sites 112, etc.).

The method 500 includes determining, with the server electronic processor 304, LMR site affiliations for each of a plurality of subscribers (at block 504). Referring to the example of FIG. 1, the server electronic processor 304 may determine that a first subscriber (e.g., the first radio device 104a) is affiliated with the first LMR site 112a, a second subscriber (e.g., the second radio device 104b) is affiliated with the first LMR site 112a, and that a third subscriber (e.g., the third radio device 104c) is affiliated with the second LMR site 112b.

The server electronic processor 304 may determine, or update, LMR site affiliations for respective subscriber radio devices 104a-c periodically and/or in response to changes in the LMR site affiliations (e.g., in response to a radio device 104 transitioning from one LMR site to another LMR site 112, or in response to a radio device 104 transitioning from one LMR site 112 to the IP-based network 120). The server electronic processor 304 may determine the LMR site affiliations based on subscriber connection information received from the LMR core 108 and/or based on subscriber connection information received from respective radio devices 104 during registration of the respective radio device 104 to the LMR over IP server 116. In some instances, the server electronic processor 304 determines the LMR site affiliations by requesting the LMR site affiliations from the LMR core 108 or from respective radio devices 104 connected to the LMR over IP server 116. The server electronic processor 304 may store the RF site affiliations in the memory 308.

The server electronic processor 304 determines that a first subscriber has disconnected from the LMR network and established a connection to a gateway associated with the LMR network (at block 508). Referring to the example of FIG. 5, the server electronic processor 304 may determine that the first radio device 104a has lost an LMR signal to the LMR sites 112 (in particular, the first LMR site 112a), and registered with the LMR over IP server 116 in order to communicate with other radio devices 104 using the IP-based network 120. The first radio device may register with the LMR over IP server 116 in response to a total or partial signal loss with respect to the LMR network. For example, the first radio device 104a may register with the LMR over IP server 116 in response to an LMR signal strength being less than a threshold.

The method 500 further includes determining, with the LMR over IP server electronic processor 304, that a radio device (e.g., any one of the radio devices 104a-104d) has initiated a site-wide call for a particular LMR site (at block 512). As an example, the server electronic processor 304 may determine that the dispatcher radio device 104d has initiated a site-wide call for the first LMR site 112a.

In response to determining that the radio device (e.g., the dispatcher radio device 104d) has initiated the site-wide call, the server electronic processor 304 determines, based on the determine LMR site affiliations, whether the first subscriber (e.g., the first radio device 104a in the example of FIG. 4) was most recently affiliated with the first LMR site 112a prior to disconnection from the LMR network and registration to the LMR over IP server 116 (at block 516).

In response to determining that the first radio device 104a was affiliated with the first LMR site 112a prior to disconnection from the LMR network (“YES” at block 516), the server electronic processor 304 includes the first radio device 104a in the site-wide call by transmitting audio associated with the site-wide call to the first radio device 104a (at block 520). For example, as part of the site-wide call, the server electronic processor 304 receives audio signals from the dispatcher radio device 104d via the LMR core 108, and transmits those audio signals to the first radio device 104a over the IP-based network 120. In other words, the server electronic processor 304 identifies which subscriber radio devices are served by the IP-based network 120, rather than the LMR network, and should be included in a site-wide call.

In response to determining that a site-wide call is initiated for a different LMR site 112 from which the first radio device 104a was most recently affiliated (“NO” at block 516), the server electronic processor 304 does not include the first radio device 104a in the site-wide call. For example, the dispatcher radio device 104d may initiate a site-wide call for the second LMR site 112b rather than the first LMR site 112a. In such instances, the server electronic processor 304 determines (at block 516) that the first radio device 104a was not previously affiliated with the second LMR site 112b and should not be included in the site-wide call for the second LMR site 112b. The server electronic processor 304 therefore refrains from transmitting audio signals associated with the site-wide call of the second LMR site 112b to the first radio device 104a (at block 524).

The server electronic processor 304 may perform the operations of blocks 516-524 with respect to each subscriber radio device that is registered with the LMR over IP server 116 (e.g., each device that served by the IP-based network 120). For example, in response to determining that a radio device 104 has initiated a site-wide call for a particular LMR site 112, the server electronic processor 304 determines, for each respective subscriber having an active IP connection to the LMR over IP server 116 (e.g., the gateway), whether the respective subscriber was most recently affiliated with the particular LMR site 112 prior to establishment of the IP connection. The server electronic processor 304 transmits, via the IP connection, the audio signals associated with the site-wide call to each respective subscriber that has the IP connection and was affiliated with the particular LMR site 112 prior to establishment of the IP connection.

As described above, a site-wide call may be initiated for a plurality of selected LMR sites 112. In such instances, the server electronic processor 304 determines, for each respective subscriber having an active IP connection to the LMR over IP server 116, whether the respective subscriber was most recently affiliated with any one of the plurality of selected LMR sites 112 prior to establishment of the IP connection. The server electronic processor 304 transmits, via the IP connection, the audio signals associated with the site-wide call to each respective subscriber that has the IP connection and was affiliated with any one of the plurality of selected LMR sites 112 prior to establishment of the IP connection.

Initiation of site-wide calling is not limited to the dispatcher radio device 104d. For example, any one of the radio devices 104a-104c may also initiate a site-wide call for a particular LMR site 112.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot process and transmit RF signals, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A communication system comprising:
an electronic processor communicatively connected to a plurality of radio frequency (RF) sites in an RF network, the electronic processor configured to
determine RF site affiliations for each of a plurality of subscribers in the RF network,
determine that a first subscriber has disconnected from the RF network and established an internet protocol (IP) connection to a gateway associated with the RF network,
determine that a radio device has initiated a site-wide call for a first RF site in the RF network,
in response to determining that the radio device has initiated the site-wide call, determine, based on the RF site affiliations, whether the first subscriber was affiliated with the first RF site prior to disconnection from the RF network,
in response to determining that, prior to disconnection from the RF network, the first subscriber was affiliated with the first RF site, transmit audio associated with the site-wide call to the first subscriber via the IP connection between the gateway and the first subscriber.

2. The communication system of claim 1, wherein the electronic processor is further configured to
determine that a second subscriber included in the plurality of radio devices has disconnected from the RF network and established an internet protocol (IP) connection to the gateway associated with the RF network,
in response to determining that the radio device has initiated the site-wide call for the first RF site, determine, based on the RF site affiliations, whether the second subscriber was affiliated with the first RF site prior to disconnection from the RF network,
in response to determining that, prior to disconnection from the RF network, the second subscriber was not affiliated with the first RF site, refrain from transmitting the audio associated with the site-wide call to the second subscriber.

3. The communication system of claim 1, wherein the electronic processor is configured to
in response to determining that the radio device has initiated the site-wide call for the first RF site, determine, for each respective subscriber of the plurality of subscribers having an IP connection to the gateway, whether the respective subscriber was affiliated with the first RF site prior to establishment of the IP connection, and
transmit, via the IP connection from the gateway, the audio associated with the site-wide call to each respective subscriber that has the IP connection and was affiliated with the first RF site prior to establishment of the IP connection.

4. The communication system of claim 1, wherein the IP connection includes at least one selected from the group consisting of a cellular network connection and a WiFi connection.

5. The communication system of claim 1, wherein the electronic processor is configured to receive the audio associated with the site-wide call from the first subscriber via a core of the RF network.

6. The communication system of claim 1, wherein the electronic processor is configured to store the RF site affiliations in a memory and update the RF site affiliations stored in the memory in response to a change in an RF site affiliation for a respective one of the plurality of subscribers.

7. The communication system of claim 1, wherein the electronic processor is configured to determine the RF site affiliations for each of the plurality of subscribers in the RF network based on subscriber connection information received from a core of the RF network.

8. The communication system of claim 1, wherein the electronic processor is configured to determine the RF site affiliation for the first subscriber by receiving subscriber connection information from the first subscriber in response to establishment, by the first subscriber, of the IP connection to the gateway.

9. The communication system of claim 1, wherein the electronic processor is configured to request the RF site affiliations from a core of the RF network.

10. The communication system of claim 1, wherein the electronic processor is communicatively connected to the plurality of RF sites via a core of the RF network.

11. The communication system of claim 1, wherein the RF network is an LMR network.

12. The communication system of claim 1, wherein the radio device has a wired or wireless connection to the RF network.

13. The communication system of claim 1, wherein the first RF site includes a first plurality of RF sites.

14. A method for a communication system, the method comprising:
determining RF site affiliations for each of a plurality of subscribers in a radio-frequency (RF) network;
determining that a first subscriber included in the plurality of subscribers has disconnected from the RF network and established an internet protocol (IP) connection to a gateway associated with the RF network;
determining that a radio device has initiated a site-wide call for a first RF site in the RF network;
in response to determining that the radio device has initiated the site-wide call, determining, based on the RF site affiliations, whether the first subscriber was affiliated with the first RF site prior to disconnection from the RF network;
in response to determining that the first subscriber was affiliated with the first RF site prior to disconnection from the RF network, transmitting audio associated with the site-wide call to the first subscriber via the IP connection between the gateway and the first subscriber.

15. The method of claim 14, further comprising:
determining that a second subscriber included in the plurality of subscribers has disconnected from the RF network and established an internet protocol (IP) connection to the gateway associated with the RF network;
in response to determining that the radio device has initiated the site-wide call for the first RF site, determining, based on the RF site affiliations, whether the second subscriber was affiliated with the first RF site prior to disconnection from the RF network; and
in response to determining that, prior to disconnection from the RF network, the second subscriber was not affiliated with the first RF site, refraining from transmitting the audio associated with the site-wide call to the second subscriber.

16. The method of claim 14, further comprising:
in response to determining that the radio device has initiated the site-wide call for the first RF site, determining, for each respective subscriber of the plurality of subscribers having an IP connection to the gateway, whether the respective subscriber was affiliated with the first RF site prior to establishment of the IP connection; and
transmitting, using the IP connection from the gateway, the audio associated with the site-wide call to each respective subscriber that has the IP connection and was affiliated with the first RF site prior to establishment of the IP connection.

17. The method of claim 14, wherein the IP connection includes at least one selected from the group consisting of a cellular network connection and a WiFi connection.

18. The method of claim 14, further comprising:
receiving the audio associated with the site-wide call from the first subscriber via a core of the RF network.

19. The method of claim 14, further comprising:
storing the RF site affiliations in a memory and updating the RF site affiliations stored in the memory in response to a change in an RF site affiliation for a respective one of the plurality of subscribers.

20. The method of claim 14, further comprising:
determining the RF site affiliations for each of the plurality of subscribers in the RF network based on subscriber connection information received from a core of the RF network.
